(19) United States
(12) Patent Application Publication
(10) Pub. No.: US 2019/0253549 A1
(43) Pub. Date: Aug. 15, 2019

(54) INCOMING CALL RATE SELECTION

(71) Applicant: Cary Skolnick, Monroe, NJ (US)

(72) Inventor: Cary Skolnick, Monroe, NJ (US)

(21) Appl. No.: 16/113,664

(22) Filed: Aug. 27, 2018

Related U.S. Application Data
(60) Provisional application No. 62/629,463, filed on Feb. 12, 2018.

(51) Int. Cl. H04M 1/725; H04M 3/42; H04M 15/18; H04W 4/24

(52) U.S. Cl. CPC H04M 1/72563; H04W 4/24; H04M 15/18; H04M 3/42042

(57) ABSTRACT

Systems, devices, and techniques are provided for incoming call rate selection. A communications device may receive an incoming call associated with an incoming calling entity identifier. An interface may display the incoming calling entity identifier and a rate selection control including a control for changing the rate of the incoming call. A selection by the user of the control for changing the rate of the incoming call may be received. The interface may display rate entry controls including a control for receiving input of a rate change for the incoming call. Input of the rate change for the incoming call may be received through the interface. The rate change may include one or both of a changed rate and a surcharge. The rate change for the incoming call may be transmitted to at least one carrier system responsible for routing the incoming call. The incoming call may be accepted.

### BACKGROUND

A smartphone user may receive incoming calls from parties that the user does not wish to talk to or receive further calls from. These calls may be automated calls from telemarketers. Automated calls from the same party may appear to come from different calling entity identifiers, such as phone numbers, to the smartphone receiving the calls. This may make it difficult for a user to manually block unwanted calls based on the calling entity identifier of the calling party detected by the smartphone. The calling entity identifiers of the unwanted calls may have an area code that may be the same as the area code of the calling entity identifier belonging to the user's smartphone. The first three digits after the area code may also be the same as the calling entity identifier belonging to the user's smartphone. This may make automated blocking of unwanted calls difficult, as a user's friends or family members may also have calling entity identifiers with the same area code and first three digits as the calling entity identifier belonging to the user's smartphone.

### BRIEF SUMMARY

According to an implementation of the disclosed subject matter, an interface of the computing device may display the incoming calling entity identifier and a rate selection control comprising a control for changing the rate of the incoming call. A selection by the user of the control for changing the rate of the incoming call may be received through the interface. The interface of the computing device may display rate entry controls including a control for receiving input of a rate change for the incoming call. Input of the rate change for the incoming call may be received through the interface. The rate change may include one or both of a changed rate and a surcharge. The rate change for the incoming call may be transmitted to at least one carrier system responsible for routing the incoming call to the computing device. The computing device may accept the incoming call.

Additional features, advantages, and implementations of the disclosed subject matter may be set forth or apparent from consideration of the following detailed description, drawings, and claims. Moreover, it is to be understood that both the foregoing summary and the following detailed description provide examples of implementations and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example interface for incoming call rate selection according to an implementation of the disclosed subject matter.

FIG. 2A shows an example interface for incoming call rate selection according to an implementation of the disclosed subject matter.

FIG. 2B shows an example interface for incoming call rate selection according to an implementation of the disclosed subject matter.

FIG. 3 shows an example interface for incoming call rate selection according to an implementation of the disclosed subject matter.

FIG. 4 shows an example interface for incoming call rate selection according to an implementation of the disclosed subject matter.

FIG. 5 shows an example arrangement for incoming call rate selection according to an implementation of the disclosed subject matter.

FIG. 6A shows an example arrangement for incoming call rate selection according to an implementation of the disclosed subject matter.

FIG. 6B shows an example arrangement for incoming call rate selection according to an implementation of the disclosed subject matter.

FIG. 6C shows an example arrangement for incoming call rate selection according to an implementation of the disclosed subject matter.

FIG. 8A shows an example arrangement for incoming call rate selection according to an implementation of the disclosed subject matter.

FIG. 8B shows an example arrangement for incoming call rate selection according to an implementation of the disclosed subject matter.

FIG. 8C shows an example arrangement for incoming call rate selection according to an implementation of the disclosed subject matter.

FIG. 9 shows an example procedure for incoming call rate selection according to an implementation of the disclosed subject matter.

FIG. 10 shows a computer according to an implementation of the disclosed subject matter.

FIG. 11 shows a network configuration according to an implementation of the disclosed subject matter.

### DETAILED DESCRIPTION

According to embodiments disclosed herein, incoming call rate selection may allow for a user to select a rate or toll charged to a party that has placed an incoming call to the user's smartphone. When a user's smartphone receives an incoming call, an existing database of calling entity identifiers and instructions for handling incoming calls from various calling entity identifiers may be checked for instructions for handling the currently incoming call based on the incoming calling entity identifier. The instructions may determine the rate at which incoming calls from calling entity identifiers stored in the database will be billed to the calling party, and whether any surcharge will be added to the amount billed to the calling party. If the incoming calling entity identifier is found in the database, the instructions in the database for billing incoming calls from the incoming calling entity identifier may be implemented. The calling party may be presented with any increased billing rate or surcharge that will be added to the bill for the call. The calling party may be given the option to either accept the increased rate and/or surcharge and continue the call, or decline the increased rate and/or surcharge, resulting in the termination of the call. If the incoming calling entity identifier is not found in the database, the user may be presented with controls on the user interface of the smartphone allowing the user to accept the call normally, accept the call while changing the rate at which the call is billed to the calling party and/or adding a surcharge, or dismiss the call. The user interface may also display the calling entity identifier of the incoming call. The controls may be displayed as part of a telephony application running on the smartphone. The controls may be built-in to the telephony application, may be implemented in a separate application on the smartphone that may operate in conjunction with the telephony application, or may be built in to the operating system of the smartphone. If the user selects to accept the call while changing the rate at which the call is billed and/or adding a surcharge, the user may be presented with additional controls which may allow the user to select whether the changed rate or surcharge should be applied for the incoming calling entity identifier for only the current call, or for future calls. If the user selects to apply the changed rate and/or surcharge to future calls for the incoming calling entity identifier, the changed rate and/or surcharge may be stored in the database with the incoming calling entity identifier. By selecting the option to accept the call while changing the rate at which the call is billed or adding a surcharge, the user may be able to selectively and temporarily turn their calling entity identifier into a toll number, or premium rate number. This may allow a user to bill calling parties for their calls placed to the user's smartphone, which may help to deter unwanted calls.

The handling of an incoming call and determining whether the incoming calling entity identifier is in the database may be performed by a telephony application, a separate application that interfaces with the telephony application, a component of an operating system, or a component of firmware or other low-level operating system of telephony device such as a smartphone. The telephony application may be any suitable application for receiving calls placed to a calling entity identifier, including telephony applications that are built-in to smartphones and interact directly with a phone carrier, for example, through a SIM card, and third-party telephony applications, which may be, for example, applications to which a calling entity identifier can be forwarded and may include other communications features that may operate based on, for example, user names or other identifiers for calling parties.

When an incoming call is detected by a telephony device, a rate change database may be searched for the incoming calling entity identifier. The rate change database may be any suitable database stored in any suitable memory of the telephony device. For example, the rate change database may be part of a contacts database already stored on the telephony device and used to display the caller ID of contact or may be a separate database that may be stored and maintained separately from any other contacts database. The incoming calling entity identifier may be a phone number, or may be, for example, an email address, username, or other identifier that may be used to identify a caller or calling party with a video or audio calling system, including, for example, Voice-Over-IP systems, Wi-Fi calling systems, and video and audio calling systems that may use data networks for transmitting streaming audio and video instead of telephony networks. The calling entity identifier may be, for example, a person, a company, an automated system, or any other entity. For purposes of determining rate schedules in all following paragraphs and method descriptions, the term telephone number may refer to a a phone number, or to any other identifier of the calling entity. Such entity may possess and use more than one phone number, or change numbers.

If the incoming calling entity identifier is not found in the rate change database, controls may be displayed to the user to allow the user to select whether to change the rate at which the call is billed and/or add a surcharge, and to specify any changed rate or surcharge amount. The control for rate selection may be built-in to a telephony application. When a telephony device, such as a smartphone, running the telephony application with the built-in control for rate selection receives an incoming call, controls may be displayed to the user allowing the user to dismiss the call, to accept the call with no rate change, or accept the call with a rate change. The controls may appear in any suitable form on the user interface of the telephony device, such as, for example, controls on the touchscreen of a smartphone. If the user selects to accept the call with no rate change, the call may be picked up and billed as normal, for example, based on the calling party's rate plan with their phone carrier, the length of the call, whether the call is local, long distance, domestic, or international, and so on.

If the user selects to the accept the call with a rate change, the call may be picked up, but the calling party may be billed at a rate that may be input by the user and may be higher than the normal rate the calling would be billed at. The telephony application may display controls that may allow the user to select or enter a changed rate at which to bill the calling party and to specify a surcharge amount that may be added to the calling party's bill for the call. The controls may appear in any suitable form on the user interface of the telephony device, such as, for example, controls on the touchscreen of a smartphone. The controls may be, for example, a dropdown a panel which may allow the user to enter the changed/rate and or surcharge or select from a number of pre-programmed rates and surcharges. The changed rate may be entered as, for example, a monetary value to be billed on a per time unit basis, such as, for example a dollar amount to be billed on a per minute basis, which may be the default time unit basis. The surcharge may be entered as a monetary value to be added whole to the bill for the incoming call.

After the user has chosen to accept the call with a rate change, and specified the changed rate and any surcharge, the user may be presented with a control that may allow the user to specify whether the changed rate and any surcharge input by the user are to be used only for the current call from the incoming calling entity identifier or for future calls from the incoming calling entity identifier. If the user selects to use the changed rate and any surcharge input by the user for future calls from the incoming calling entity identifier, the changed rate and any surcharge input by the user may be stored in the rate change database along with the incoming calling entity identifier. Any future incoming call received from the incoming calling entity identifier may result in the incoming calling entity identifier being found the rate change database. The changed rate and any surcharge stored in the rate changed database with the incoming calling entity identifier may be retrieved and automatically used for that future incoming call without requiring the user to select to use a changed rate for the incoming call or re-input the changed rate and any surcharge.

The controls for incoming call rate selection, including rate selection controls for choosing to whether to change the rate for an incoming call, rate entry control for specifying the changed rate and any surcharge, and rate storage controls for selecting whether to store a changed rate in the rate change database, may be part of a separate component that may run on a user's telephony device, such as smartphone, alongside a telephony application. The separate component may be, for example, an application, a part of the operating system, a part of the firmware or other low-level operating system running on the telephony device. The separate component may implement the incoming call rate selection controls in any suitable manner. For example, the separate component may be able to directly integrate itself with the user interface of the telephony application, for example, through an application programming interface (API) such that the incoming call rate selection controls may appear as if they are part of the telephony application during an incoming call. The separate component may implement the controls separately. For example, when the telephony device receives an incoming call, the telephony application may automatically take over the foreground of the telephony device's display, and the separate component may display a rate selection control that appears overtop of the telephony application, for example, as a notification. The separately displayed incoming call rate selection controls may interact directly with the telephony application, so that using the controls may allow the user to choose to change the rate, specify the changed rate and any surcharge, and accept the call at the same time. The separately displayed controls may also operate separately from the telephony application, such that the user may use the incoming call rate selection controls to change the rate and specify any surcharge for the call but may then need to accept the call normally using the telephony application.

If the incoming calling entity identifier is found in the rate change database, instructions associated with the incoming calling entity identifier may be retrieved from the database. The instructions may specify a changed rate at which the calling party will be billed and/or a surcharge that will be added to the calling party's bill for the call. The changed rate and any surcharge may be automatically used to bill the incoming call from the incoming calling entity identifier that was found in the rate change database. The user may not be presented with the incoming call rate selection controls used to accept the call with a rate change, specify a rate change and/or surcharge, or select whether to use the changed rate and/or surcharge for future calls from the incoming calling entity identifier. The call may be automatically accepted using the changed rate and/or surcharge retrieved from the rate change database without displaying any controls to the user and without input from the user, or the user may be presented with controls to accept or reject the call, with the changed rate and/or surcharge being applied automatically if the user chooses to accept the call.

If a changed rate and/or surcharge was found in the database for the incoming calling entity identifier, or the user selects to accept the call with a rate change, the calling party may be informed that the billing rate for the call has changed. The calling party may be presented with an indication of the changed rate and/or surcharge that will be billed to the calling party if they proceed with the call. The indication may be, for example, a display on a screen of a telephony device used by the calling party or may be audio transmitted to the telephony device used by the calling party. The indication may be provided to the telephony device of the calling party by, for example, the carrier of the calling party, or the carrier of the user. The calling party may choose to accept the changed rate and/or surcharge and proceed with the call or may choose to decline the changed rate and/or surcharge and terminate the call. This may give the calling party a chance to end the call before being billed. The calling party may be presented with controls to select whether to accept the changed rate/and or surcharge or decline the call. The controls may be, for example, buttons presented on user interface of a display of a telephony device with a screen, or a voice menu from which the user may select an option via voice command or dial-pad input on their telephony device. The controls may include a default option if no input is received from the calling party for some specified period of time after the controls are presented to the calling party. The default may be, for example, proceeding with the call using the changed rate and/or surcharge, or may be terminating the call.

If the calling party chooses to accept the changed rate and/or surcharge, or the acceptance occurs by default, the call may proceed between the user's telephony device and the calling party's telephony device, and the call may be billed to the calling party using the changed rate, and any surcharge may be added to the bill for the call. The changed rate may be set on, for example, a per minute basis, and the call may then be billed based on the length of the call, while any surcharge may be added to the per-minute bill for the call. If the calling party uses a different phone carrier than the user of the called smartphone, either of both the phone carriers may be responsible for implementing the rate change and billing the calling party. Additionally, some portion of the amount billed to the calling party may be remitted to the user of the smartphone, or to another party financially responsible for the smartphone. For example, some portion of the billed amount may appear as a credit on the bill from the user's phone carrier for the smartphone's service.

The rate change may be implemented in any suitable manner. For example, a rate change and/or surcharge based on a user's selection or instructions from the rate change database may be transmitted to the systems of the user's carrier, the calling party's carrier, or both carriers. A carrier's system that receives a changed rate and/or surcharge from the user's telephony device may automatically implement the requested rate change and/or surcharge and may also automatically reverse the rate change when the call concludes. In some implementations, the selection to answer an incoming call with a rate change, or changed rate being found in the rate change database for the incoming calling entity identifier, may cause the incoming call to be routed to a second calling entity identifier. The second calling entity identifier may be a toll, or premium rate, number, and may be controlled by a carrier, such as the user's carrier, or by a third party. The incoming call may then be routed from the second calling entity identifier back to the user's calling entity identifier, such that the user may accept the call on their telephony device while the call is connected to the second calling entity identifier. The calling party may thus be billed at the selected rate for the time spent connected to the second calling entity identifier, which may be for the duration of the call to the user's calling entity identifier. This implementation may result in the user's telephony device receiving two calls, as routing the incoming call to the second calling entity identifier may terminate the original call to the user's telephony device, and routing the call back to the user's telephony device from the second number may result in a call from the second number to the user's telephony device which the user may answer normally to commence the rate changed call.

The user may be able to set the rate at which the calling party is billed in any suitable manner. The user may be able to set a changed rate and/or surcharge for a calling entity identifier outside of a call. For example, the telephony application, or separate application or component, may allow the user to edit the rate change database. The user may be able to add and remove calling entity identifiers from the rate change database and make changes to the changed rates and surcharges stored in the rate change database along with the calling entity identifiers. The user may also be able change the billing rate on a per-call basis. For example, the incoming call rate selection controls that appear on the user interface when the user's telephony device receives an incoming call may include various billing rate options the user may select, including, for example, a default changed rate, or a changed rate that may have been previously set by the user for the incoming calling entity identifier and stored in the rate change database, or may allow a user to enter a new billing rate, so that the billing rate may be set in conjunction with the user selecting to accept the call and change the rate.

In some implementations, the incoming call rate selection controls may only be displayed when the calling entity identifier on an incoming call is not recognized. For example, when a user's smartphone receives an incoming call that comes from a calling entity identifier that is in the smartphone's contact database, separate from the rate exchange database, the incoming call rate selection controls may not be displayed. This may prevent the user from accidentally selecting to the change the rate for incoming call from friends, family, or other associates that the user would not want to deter from calling. The user of a smartphone may also be able to designate which contacts the rate for control selection is displayed for. This may be implemented, for example, through a contact editing function of a contacts application on the user's smartphone. This may also be implemented through the separate application or component for rate selection, which may maintain the separate rate change database of calling entity identifiers and allow the user to select whether the incoming call rate selection controls should be presented for each calling entity identifier.

A separate application or component for rate selection may interface with components of the smartphone and other applications, such as a telephony application, in any suitable manner. For example, the separate application for rate selection may use APIs to access functions of the operating system of the smartphone and the telephony application, for example, to detect incoming calls, display controls on a touchscreen, receive input from a touchscreen, add controls to the interface a telephony application, and communicate with remote devices such as carrier systems.

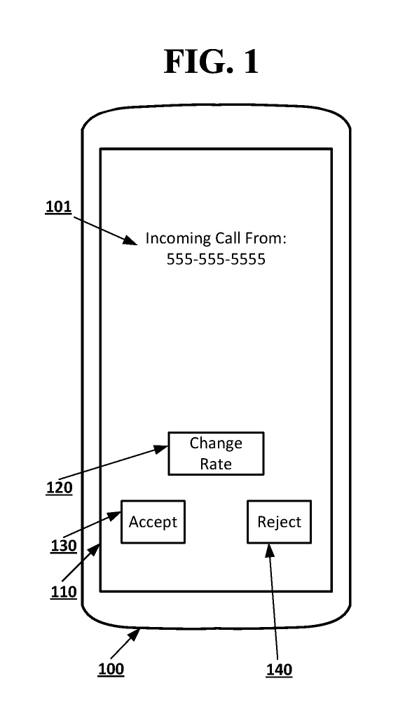

FIG. 1 shows an example interface for incoming call rate selection according to an implementation of the disclosed subject matter. A telephony computing device 100, such as a smartphone, may include a display 110, which may be, for example, a touchscreen. A telephony application on the telephony computing device 100 may have a built-in control for rate selection, or a separate component, such as an application, operating system component, or firmware component, may include controls for rate selection. When there is an incoming call to the telephony computing device 100, rate selection controls, including an incoming call notification 101, accept control 130, reject control 140, and rate selection control 120 may be displayed on the telephony computing device 100. The displaying of the call notification 101, accept control 130, reject control 140, and rate selection control 120 may be handled by any suitable combination of any components of the telephony computing device 100, including a telephony application and any separate component that may include the controls for rate selection. For example, the telephony application may handle the display of all of the call notification 101, accept control 130, reject control 140, and rate selection control 120, or may handle the display of the call notification 101, accept control 130, and reject control 140, while a separate component, which may be activated by the incoming call, may handle the display of the rate selection control 120. In some implementations, the separate component may handle the display of the call notification 101, accept control 130, reject control 140, and rate selection control 120, and the controls may interface with the telephony application, for example, through an API. The user may select the accept control 130 to accept the call without changing the rate at which the call will be billed. The user may select the reject control 140 to reject or dismiss the call. The user may select or activate the rate selection control 120, for example, pressing the location of the control on the touchscreen 110, to change the rate at which the incoming call is billed and accept the incoming call.

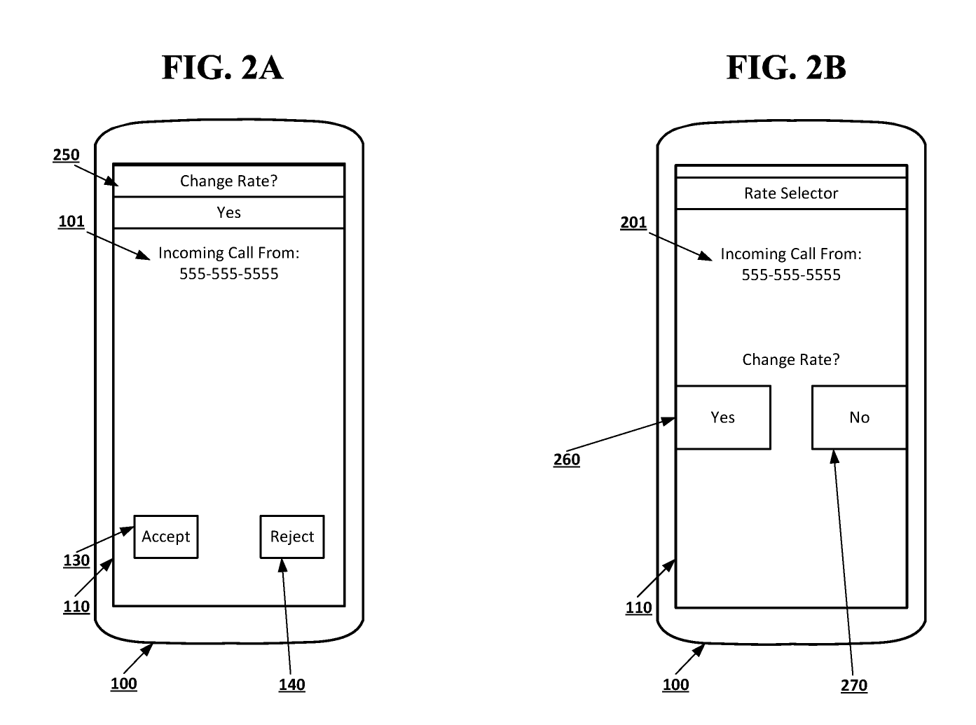

FIG. 2A shows an example interface for incoming call rate selection according to an implementation of the disclosed subject matter. The control for rate selection may be implemented by a separate rate selection application on the telephony computing device 100. When there is an incoming call to the telephony computing device 100, a telephony application may display an incoming call notification 101, accept control 130, and reject control 140. The rate selection application may display rate selection control 250, for example, as a notification overtop of the user interface displayed by the telephony application. The rate selection control 250 may include a “yes” control which may be selected by the user. The user may select or activate the rate selection control 250, for example, pressing the location of the “yes” control on the touchscreen 110, to change the rate at which the incoming call is billed and accept the incoming call. The user may use the accept control 130 and reject control 140 to accept or reject the call without changing the rate at which the call is billed.

FIG. 2B shows an example interface for incoming call rate selection according to an implementation of the disclosed subject matter. The control for rate selection may be implemented by a separate rate selection application on the telephony computing device 100. When there is an incoming call to the telephony computing device 100, the rate selection application may display an interface including the incoming call notification 201, which may be similar to the incoming call notification 101, the “yes” control 260, and the “no” control 270. The user may select or activate the rate selection control, for example, pressing the location of the “yes” control 260 on the touchscreen 110, to change the rate at which the incoming call is billed. The user may use the “no” control 270 to dismiss the rate selection control 250. Selecting the “yes” control 260 may automatically accept the incoming call in the telephony application, or may allow the telephony application to display the accept control 130 and reject control 140 on the touchscreen 110, dismissing the interface for the rate selection application. Selecting the “no” control may dismiss the interface for the rate selection and allow the interface for the telephony application to be displayed without changing the billing rate for the call.

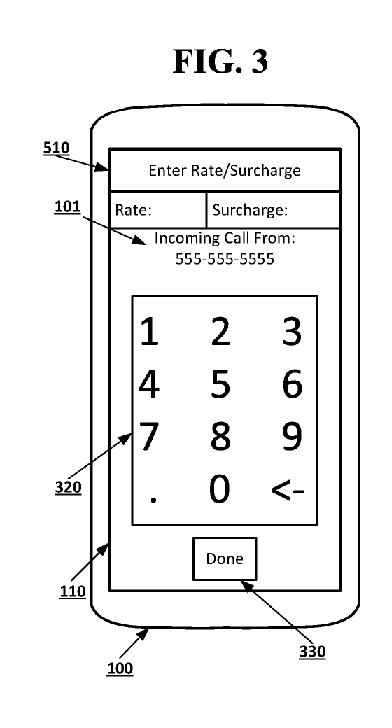

FIG. 3 shows an example interface for incoming call rate selection according to an implementation of the disclosed subject matter. After a user has chosen to accept the call with a changed rate, for example, by using the rate selection control 120, the display 110 of the telephony computing device 100 may display an interface that may allow the user to enter the rate at which the calling party will be billed for the incoming phone call along with any surcharge the user may wish to impose. For example, a dropdown panel 310 may include an area into which the user may input the changed rate that will be used to bill the incoming call, and an area into which the user may input any surcharge they wish to impose on the incoming call. The user may use a displayed number pad 320 to enter the changed rate and the surcharge. The changed rate and surcharge may be input as, for example, a monetary value, such as dollars and cents. The changed rate may be a per minute rate or may be billed based on any other unit of time, which may be based on a default, or may be input by the user. The interface may include a done control 330, which the user may select when they are finished entering the changed rate for the call and any surcharge.

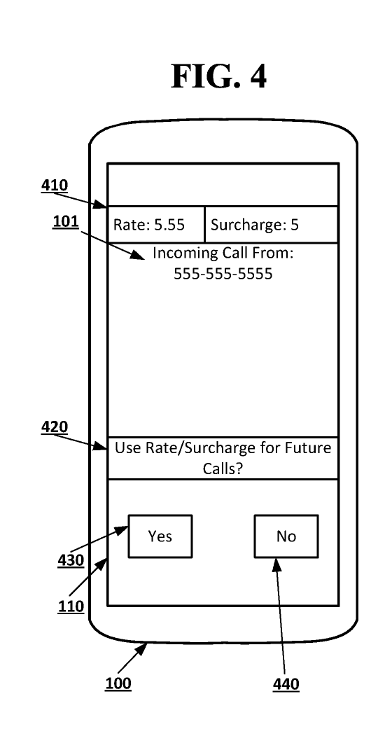

FIG. 4 shows an example interface for incoming call rate selection according to an implementation of the disclosed subject matter. After a user has indicated that they are finished entering a changed rate and any surcharge, for example, by using the done control 330, the display 110 of the telephony computing device 100 may display an interface that may allow the user to choose whether the entered changed rate and any surcharge will be used for future calls from the incoming calling entity identifier or only for the current call from the incoming calling entity identifier. For example, the changed rate and surcharge entered by the user may be displayed in the panel 410, and notification 420 may indicate to the user that they can choose to use the changed rate and surcharge for future calls from the incoming calling entity identifier, and the yes control 430 and no control 420 may allow the user to make their choice. If the user selects the yes control 430, the changed rate and any surcharge entered by the user, and displayed in the area 410, may be stored in a rate change database along with the incoming calling entity identifier for retrieval when future calls are received from the incoming calling entity identifier. The incoming call may then proceed, being billed at the changed rate and with any surcharge, as displayed in the area 410, if the changed rate and any surcharge are accepted by the calling party. If the user selects the no control 440, the changed rate and any surcharge may not be stored in the database, and the call may then proceed at the changed rate and with any surcharge, as displayed in the area 410, if the changed rate and any surcharge are accepted by the calling party.

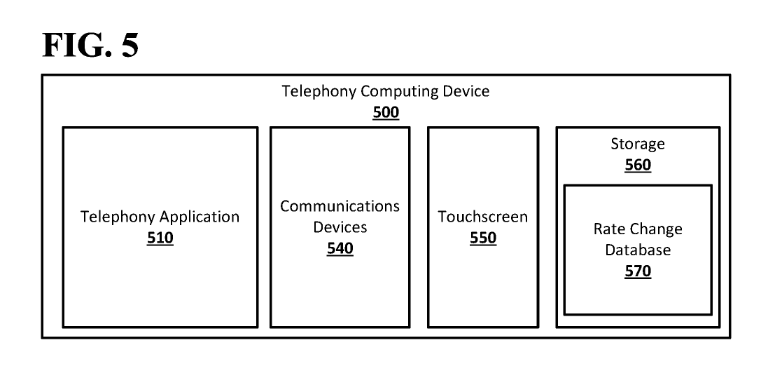

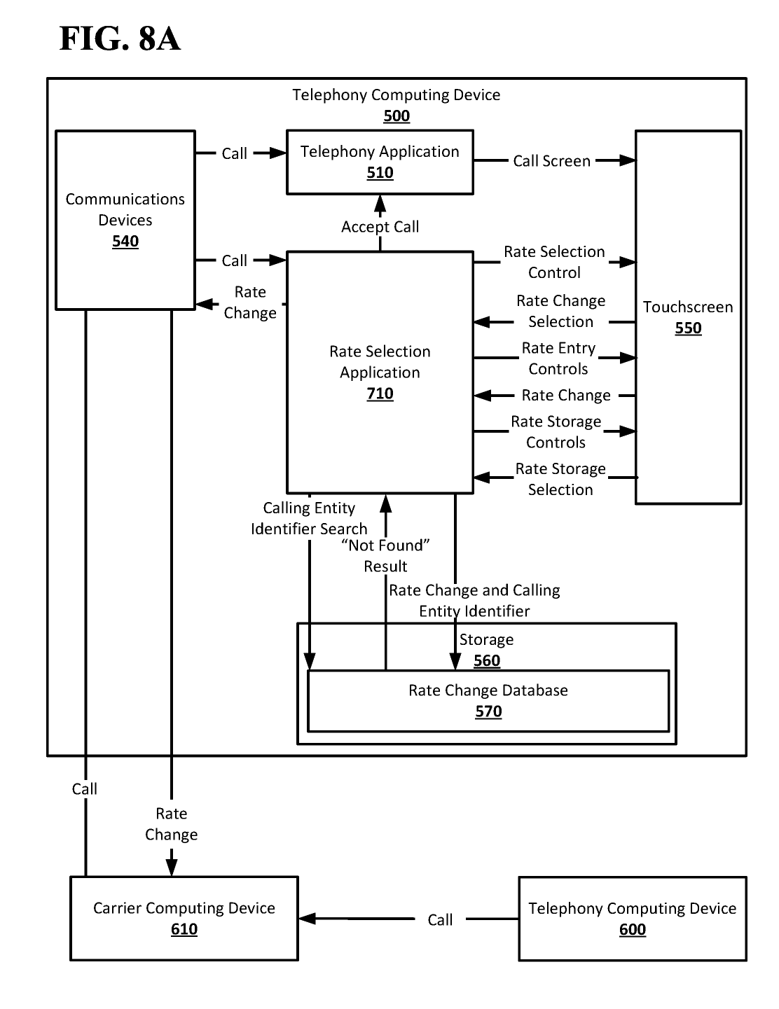

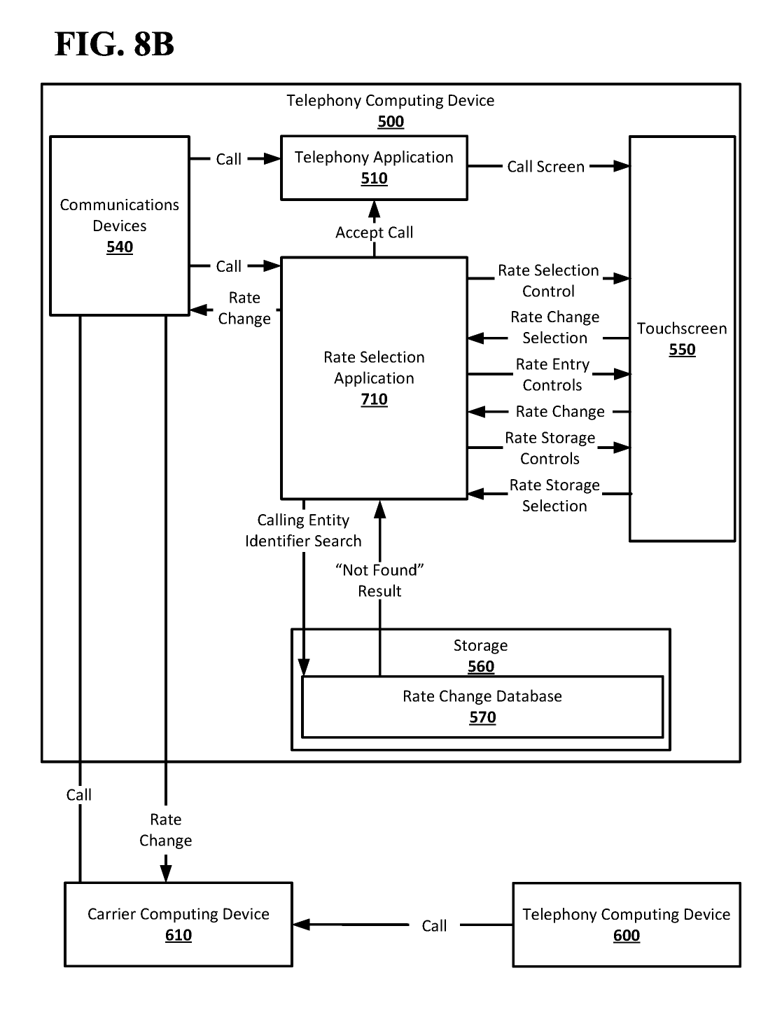

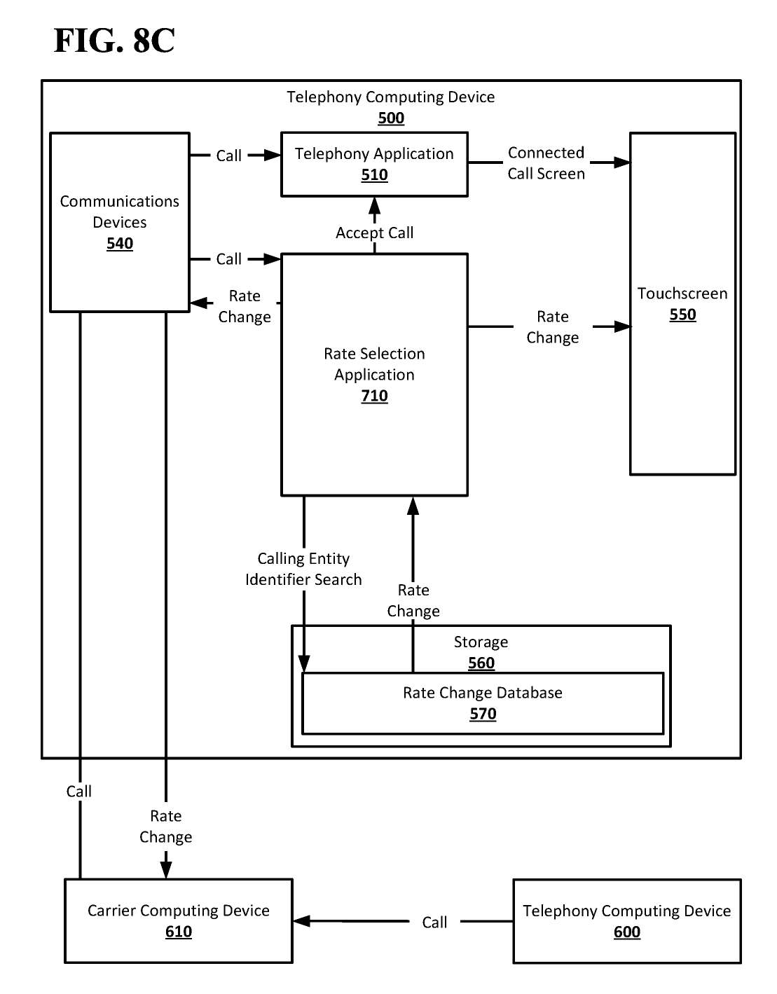

FIG. 5 shows an example arrangement for incoming call rate selection according to an implementation of the disclosed subject matter. A telephony computing device 500 may include a telephony application 510, communications devices 540, which may be cellular radios, Wi-Fi radios, other radios, or wired communications devices, a touchscreen 550, and a storage 560. The telephony computing device 500 may be, for example, any suitable device, such as, for example, a computer 20 as described in FIG. 8, for implementing the telephony application 510, the communications devices 540, the touchscreen 550, and the storage 560. The telephony computing device 500 may be a single computing device, or may include multiple connected computing devices, and may be, for example, a mobile computing device, such as a tablet, smartphone, or laptop, or other computing device, such as a desktop, smart television, or media streaming device.

The telephony application 510 may be any suitable application for telephony that may run on the telephony computing device 500. The telephony application 510 may, for example, use cellular telephony, Voice-Over-IP telephony, Wi-Fi telephony, landline telephony, or streaming audio or video telephony. The telephony application 510 may be integrated with a carrier which may be responsible for billing communications, such as calls including audio and/or video, to and from the telephony application 510.

The communications devices 540 may be any suitable hardware communications devices and associated software for communicating data to and from the telephony computing device 500. For example, the communications devise 540 may include any of Wi-Fi radios, cellular radios, other radios, and wired communications devices including telephone landline communications devices and ethernet or other network communications devices. The communications devices 540 may be used to communicate data for calls to and from the telephony application 510.

The touchscreen 550 may be any suitable combination of hardware and software for implementing a display that may accept touch input from a user. In some implementations, the telephony computing device 500 may use other types of hardware to receive input from a user, including, for example, a keyboard, a mouse, trackpad, voice input, or hardware buttons such as, for example, a hardware dial pad.

The storage 560 may be any suitable combination of hardware and software for implementing a storage device that may be located on or otherwise accessible to the telephony computing device 500. The storage 560 may use any combination of volatile and non-volatile storage of any suitable types, arranged in any suitable manner. A rate change database 570 may be stored in the storage 560. The rate change database 570 may store calling entity identifiers and associated rate changes, including changed rates and surcharges, to be used when incoming calls are received from the stored calling entity identifiers. Each stored calling entity identifier in the rate change database 570 may be associated with its own changed rate and surcharge, which may have been previously entered by the user. The rate change database 570 may be part of a contacts database on the telephony computing device 500 or may be a separate database.

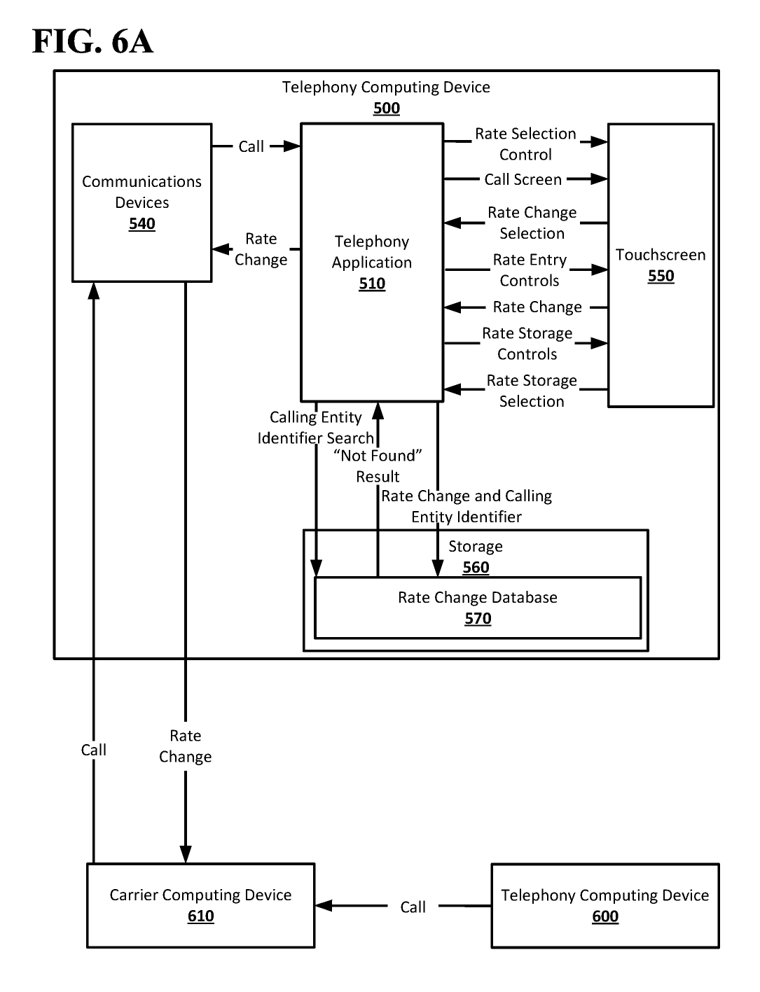

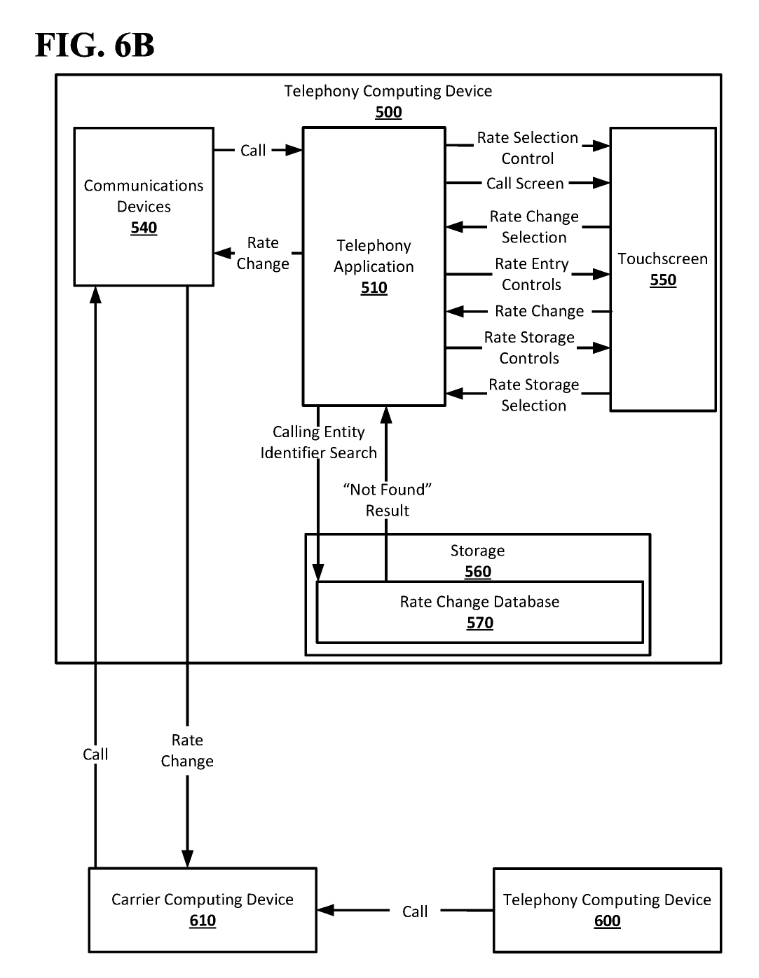

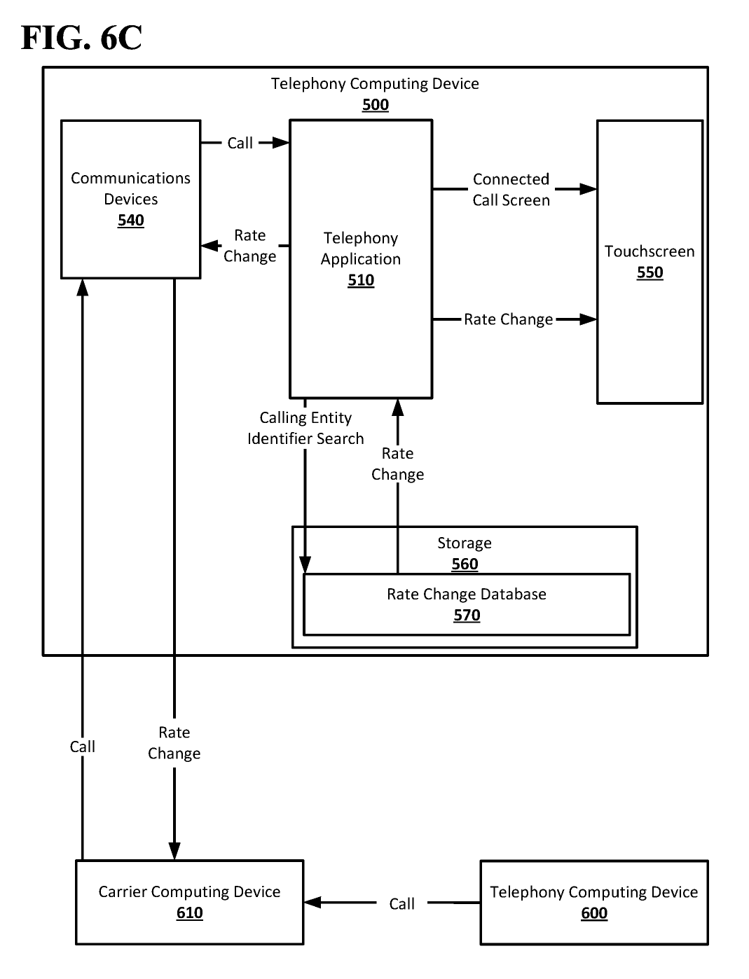

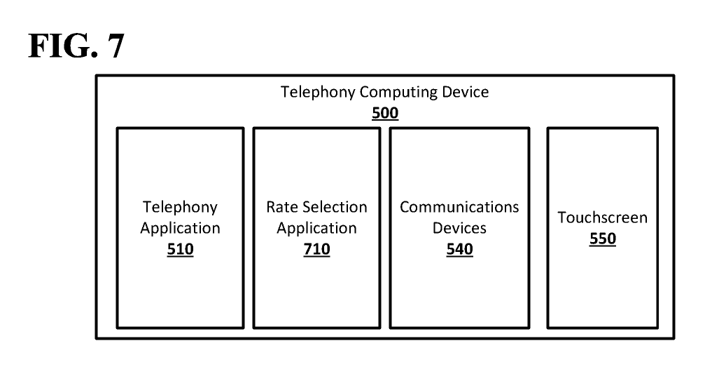

FIG. 6A shows an example arrangement for incoming call rate selection according to an implementation of the disclosed subject matter. When a telephony computing device 600 places a call to the telephony computing device 500, the call may be routed through carrier computing device 610, belonging to a carrier, to the communications devices 540 of the telephony computing device 500. The telephony application 510 may receive the incoming call and may search the rate change database 570 for the incoming calling entity identifier. If the incoming calling entity identifier is not already stored in the rate change database 570, a “not found” search result may be returned to the telephony application 510. The telephony application 510 may then display the rate selection control and call screen, including the incoming call notification, accept control, and reject control, on the touchscreen 550. If the user selects or activates the rate selection control, choosing to accept the call with a rate change, the telephony application 510 may display rate entry controls on the touchscreen 550. The rate entry controls may allow the user to input a rate change, including a changed rate for billing on time unit basis and any surcharge, to be used when billing to the calling party.

After the user has indicated that they are done entering the rate change using the rate entry controls, the telephony application 510 may display the rate storage controls on the touchscreen 550. The rate storage controls may allow the user to choose whether to use the rate change input by the user for the incoming calling entity identifier when billing future calls from the incoming calling entity identifier. The user may use the rate storage controls to select to use the rate change for future calls from the incoming calling entity identifier. The telephony application 510 may store the incoming calling entity identifier and the rate change, including the changed rate and any surcharge, in the rate change database 570.

The telephony application 510 may accept the call and may use the communications devices 540 to communicate the selection to change the rate at which the incoming call is billed and the rate change to the carrier computing device 610, the changed rate and any surcharge input by the user using the rate entry controls. The carrier computing device 610 may then bill the incoming call to the calling party responsible for the telephony computing device 600 at the changed rate, which may be higher than a normal, non-changed rate, and with any surcharge. The carrier computing device 610 may also credit the party responsible for the telephony computing device 500 for some portion of the amount billed based on the changed rate.

FIG. 6B shows an example arrangement for incoming call rate selection according to an implementation of the disclosed subject matter. When the telephony computing device 600 places a call to the telephony computing device 500, the call may be routed through carrier computing device 610, belonging to a carrier, to the communications devices 540 of the telephony computing device 500. The telephony application 510 may receive the incoming call and may search the rate change database 570 for the incoming calling entity identifier. If the incoming calling entity identifier is not already stored in the rate change database 570, a “not found” search result may be returned to the telephony application 510. The telephony application 510 may then display the rate selection control and call screen, including the incoming call notification, accept control, and reject control, on the touchscreen 550. If the user selects or activates the rate selection control, choosing to accept the call with a rate change, the telephony application 510 may display rate entry controls on the touchscreen 550. The rate entry controls may allow the user to input a rate change, including a changed rate for billing on time unit basis and any surcharge, to be used when billing to the calling party.

After the user has indicated that they are done entering the rate change using the rate entry controls, the telephony application 510 may display the rate storage controls on the touchscreen 550. The rate storage controls may allow the user to choose whether to use the rate change input by the user for the incoming calling entity identifier when billing future calls from the incoming calling entity identifier. The user may use the rate storage controls to select not to use the rate change for future calls from the incoming calling entity identifier. The telephony application 510 may not store the incoming calling entity identifier and the rate change in the rate change database 570.

The telephony application 510 may accept the call and may use the communications devices 540 to communicate the selection to change the rate at which the incoming call is billed and the rate change to the carrier computing device 610, including the changed rate and any surcharge input by the user using the rate entry controls. The carrier computing device 610 may then bill the incoming call to the calling party responsible for the telephony computing device 600 at the changed rate, which may be higher than a normal, non-changed rate, and with any surcharge. The carrier computing device 610 may also credit the party responsible for the telephony computing device 500 for some portion of the amount billed based on the changed rate.

FIG. 6C shows an example arrangement for incoming call rate selection according to an implementation of the disclosed subject matter. When a telephony computing device 600 places a call to the telephony computing device 500, the call may be routed through carrier computing device 610, belonging to a carrier, to the communications devices 540 of the telephony computing device 500. The telephony application 510 may receive the incoming call and may search the rate change database 570 for the incoming calling entity identifier. If the incoming calling entity identifier is already stored in the rate change database 570, a rate change associated with the incoming calling entity identifier in the rate change database 570 may be returned to the telephony application 510. The rate change may include a changed rate and any surcharge previously input by the user for use in billing calls from the incoming calling entity identifier. The telephony application 510 may automatically accept the incoming call and display a connected call screen and the details of the rate change on the touchscreen 550. The connected call screen may be, for example, the standard in-call screen for the telephony application 510 including, for example, the incoming calling entity identifier, a timer tracking the current length of the call, and various controls for use in-call. The details of the rate change, including the changed rate and any surcharge, may also be displayed so that the user may be aware of the rates at which the calling party is being billed for the call.

The telephony application 510, on accepting the call, may use the communications devices 540 to communicate the rate change from the rate change database 570 to the carrier computing device 610, including the changed rate and any surcharge included in the rate change from the rate change database 570. The carrier computing device 610 may then bill the incoming call to the calling party responsible for the telephony computing device 600 at the changed rate, which may be higher than a normal, non-changed rate, and with any surcharge. The carrier computing device 610 may also credit the party responsible for the telephony computing device 500 for some portion of the amount billed based on the changed rate.

FIG. 7 shows an example arrangement for incoming call rate selection according to an implementation of the disclosed subject matter. In some implementations, rate selection may be handled by a separate component from the telephony application 510. For example, the telephony computing device 500 may include the telephony application 510, a rate selection application 710, the communications devices 540, which may be cellular radios, Wi-Fi radios, the touchscreen 550, and the storage 560. The rate selection application 710 may be any suitable combination of hardware and software for handling rate selection for incoming calls, and may be, for example, an application that is separate from the telephony application 510, a component of the operating system of the telephony computing device 500, or a component of the firmware or other low-level operating system of the telephony computing device 500. The rate selection application 710 may handle non-telephony aspects of changing the rate for an incoming call, including, for example, searching the rate change database 570 for an incoming calling entity identifier and retrieving rate changes from the rate change database 570, displaying rate selection controls, rate entry controls, and rate storage controls to the user on the touchscreen 550 and receiving input from the controls, and communicating any rate change to the carrier computing device 400 through the communications devices 540.

FIG. 8A shows an example arrangement for incoming call rate selection according to an implementation of the disclosed subject matter. When a telephony computing device 600 places a call to the telephony computing device 500, the call may be routed through carrier computing device 610, belonging to a carrier, to the communications devices 540 of the telephony computing device 500. The telephony application 510 may receive the incoming call. The rate selection application 710 may also receive the incoming call, either from the communications devices 540 or the telephony application 510 and may search the rate change database 570 for the incoming calling entity identifier. If the incoming calling entity identifier is not already stored in the rate change database 570, a “not found” search result may be returned to the telephony application 510. The telephony application 510 may then display the call screen, including the incoming call notification and accept control and reject control on the touchscreen 550, and the rate selection application 710 may display the rate selection control on the touchscreen 550. The rate selection control may be displayed as integrated with the call screen, as a notification appearing on the call screen, or overtop of the call screen, such that the call screen is hidden until the rate selection control is activated or dismissed. If the user selects or activates the rate selection control, choosing to accept the call with a rate change, the rate selection application 710 may display rate entry controls on the touchscreen 550. The rate entry controls may allow the user to input a rate change, including a changed rate for billing on time unit basis and any surcharge, to be used when billing to the calling party.

After the user has indicated that they are done entering the rate change using the rate entry controls, the rate selection application 710 may display the rate storage controls on the touchscreen 550. The rate storage controls may allow the user to choose whether to use the rate change input by the user for the incoming calling entity identifier when billing future calls from the incoming calling entity identifier. The user may use the rate storage controls to select to use the rate change for future calls from the incoming calling entity identifier. The rate selection application 710 may store the incoming calling entity identifier and the rate change, including the changed rate and any surcharge, in the rate change database 570.

The rate selection application 710 may use the communications devices 540 to communicate the selection to change the rate at which the incoming call is billed and the rate change to the carrier computing device 610, including the changed rate and any surcharge input by the user using the rate entry controls. The rate selection application 710 may also cause the telephony application 510 to accept the call. The carrier computing device 610 may then bill the incoming call to the calling party responsible for the telephony computing device 600 at the changed rate, which may be higher than a normal, non-changed rate, and with any surcharge. The carrier computing device 610 may also credit the party responsible for the telephony computing device 500 for some portion of the amount billed based on the changed rate.

FIG. 8B shows an example arrangement for incoming call rate selection according to an implementation of the disclosed subject matter. When a telephony computing device 600 places a call to the telephony computing device 500, the call may be routed through carrier computing device 610, belonging to a carrier, to the communications devices 540 of the telephony computing device 500. The telephony application 510 may receive the incoming call. The rate selection application 710 may also receive the incoming call, either from the communications devices 540 or the telephony application 510 and may search the rate change database 570 for the incoming calling entity identifier. If the incoming calling entity identifier is not already stored in the rate change database 570, a “not found” search result may be returned to the telephony application 510. The telephony application 510 may then display the call screen, including the incoming call notification and accept control and reject control on the touchscreen 550, and the rate selection application 710 may display the rate selection control on the touchscreen 550. The rate selection control may be displayed as integrated with the call screen, as a notification appearing on the call screen, or overtop of the call screen, such that the call screen is hidden until the rate selection control is activated or dismissed. If the user selects or activates the rate selection control, choosing to accept the call with a rate change, the rate selection application 710 may display rate entry controls on the touchscreen 550. The rate entry controls may allow the user to input a rate change, including a changed rate for billing on time unit basis and any surcharge, to be used when billing to the calling party.

After the user has indicated that they are done entering the rate change using the rate entry controls, the rate selection application 710 may display the rate storage controls on the touchscreen 550. The rate storage controls may allow the user to choose whether to use the rate change input by the user for the incoming calling entity identifier when billing future calls from the incoming calling entity identifier. The user may use the rate storage controls to select to use the rate change for future calls from the incoming calling entity identifier. The rate selection application 710 may store the incoming calling entity identifier and the rate change, including the changed rate and any surcharge, in the rate change database 570. The user may use the rate storage controls to select not to use the rate change for future calls from the incoming calling entity identifier. The rate selection application 710 may not store the incoming calling entity identifier and the rate change in the rate change database 570.

The rate selection application 710 may use the communications devices 540 to communicate the selection to change the rate at which the incoming call is billed and the rate change to the carrier computing device 610, including the changed rate and any surcharge input by the user using the rate entry controls. The rate selection application 710 may also cause the telephony application 510 to accept the call. The carrier computing device 610 may then bill the incoming call to the calling party responsible for the telephony computing device 600 at the changed rate, which may be higher than a normal, non-changed rate, and with any surcharge. The carrier computing device 610 may also credit the party responsible for the telephony computing device 500 for some portion of the amount billed based on the changed rate.

FIG. 8C shows an example arrangement for incoming call rate selection according to an implementation of the disclosed subject matter. When a telephony computing device 600 places a call to the telephony computing device 500, the call may be routed through carrier computing device 610, belonging to a carrier, to the communications devices 540 of the telephony computing device 500. The telephony application 510 may receive the incoming call. The rate selection application 710 may also receive the incoming call, either from the communications devices 540 or the telephony application 510 and may search the rate change database 570 for the incoming calling entity identifier. If the incoming calling entity identifier is already stored in the rate change database 570, a rate change associated with the incoming calling entity identifier in the rate change database 570 may be returned to the rate selection application 710. The rate change may include a changed rate and any surcharge previously input by the user for use in billing calls from the incoming calling entity identifier. The rate selection application 710 may cause the telephony application 510 to automatically accept the incoming call and display a connected call screen on the touchscreen 550, and the rate selection application 710 may display details of the rate change on the touchscreen 550. The connected call screen may be, for example, the standard in-call screen for the telephony application 510 including, for example, the incoming calling entity identifier, a timer tracking the current length of the call, and various controls for use in-call. The details of the rate change, including the changed rate and any surcharge, may also be displayed so that the user may be aware of the rates at which the calling party is being billed for the call.

The rate selection application 710 may use the communications devices 540 to communicate the rate change from the rate change database 570 to the carrier computing device 610, including the changed rate and any surcharge included in the rate change from the rate change database 570. The carrier computing device 610 may then bill the incoming call to the calling party responsible for the telephony computing device 600 at the changed rate, which may be higher than a normal, non-changed rate, and with any surcharge. The carrier computing device 610 may also credit the party responsible for the telephony computing device 500 for some portion of the amount billed based on the changed rate.

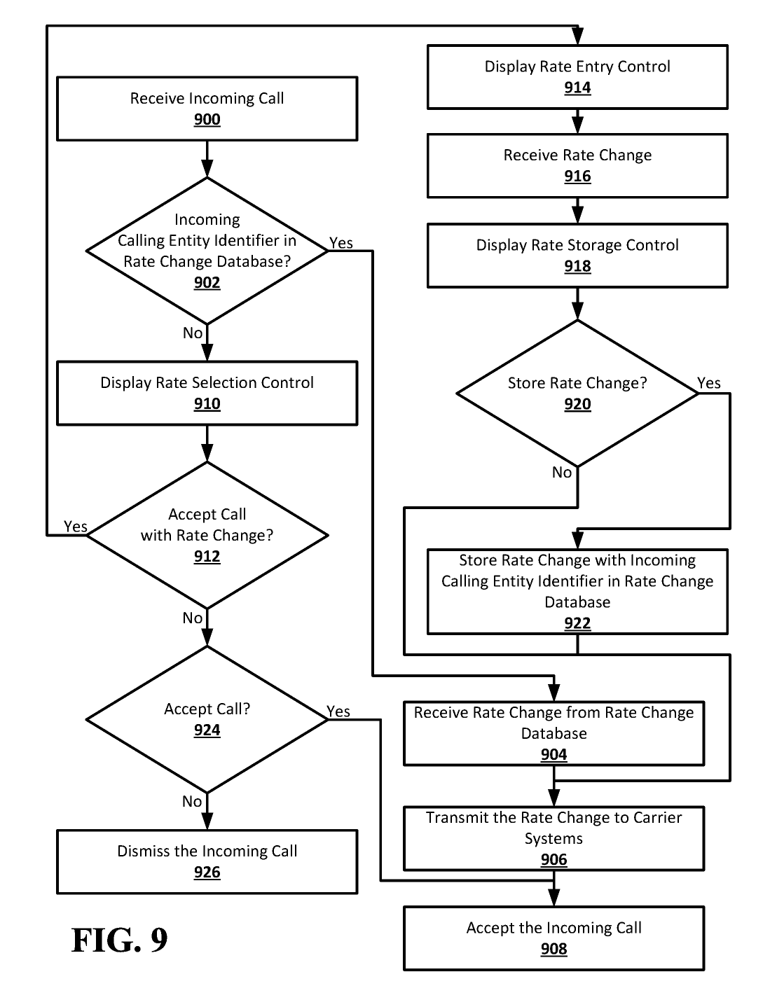

FIG. 9 shows an example procedure for incoming call rate selection according to an implementation of the disclosed subject matter. At 900, an incoming call may be received. For example, a call placed using the telephony computing device 600 may be received at the telephony computing device 500.

At 902, if an incoming calling entity identifier for the incoming call is in a rate change database, flow may proceed to 904. Otherwise, flow may proceed to 910. For example, the telephony application 510, or rate selection application 710, of the telephony computing device 500 may search the rate change database 570 for the incoming calling entity identifier for the incoming call from the telephony computing device 600.

At 904, a rate change may be received from the rate change database. For example, the telephony application 510, or rate selection application 710, may have found the incoming calling entity identifier in the rate change database 570. The rate change, including a changed rate and any surcharge, associated with the incoming calling entity identifier in the rate change database 570 may be retrieved.

At 906, the rate change may be transmitted to a carrier. For example, the telephony application 510, or rate selection application 710, may use the communications devices 540 to transmit the rate change to the carrier computing device 610. The carrier may use the rate change received at the carrier computing device 610 to send a notification of the rate change to the telephony computing device 600, and to implement the rate change, including a changed rate on a per time unit basis and any surcharge, when billing the calling party if the calling party chooses to continue with the call.

At 908, the incoming call may be accepted. For example, the telephony application 510 may accept the call if the calling party has not chosen to end the call. The call may be billed at the changed rate from any rate change, or at the normal rate if the user of the telephony computing device 500 did not implement a rate change and no rate change was found for the incoming calling entity identifier in the rate change database 570.

At 910, a rate selection control may be displayed. For example, the incoming calling entity identifier may not have been found in the rate change database 570. The telephony application 510, or rate selection application 710, may display a rate selection control, for example, on the touchscreen 550 of the telephony computing device 500. The rate selection control may allow the user to choose whether to accept that incoming call, dismiss the incoming call, or accept the incoming call with rate change that will change the rate at which the incoming call will be billed to the calling party.

At 912, if the call is accepted with a rate change, flow may proceed to 914.

Otherwise, flow may proceed to 924. For example, the user may use the rate selection control on the touchscreen 550 to indicate acceptance of the call with a rate change.

At 914, rate entry controls may be displayed. For example, the user may have selected to accept the incoming call with a rate change using the rate selection control. The telephony application 510, or rate selection application 710, may display a rate entry control, for example, on the touchscreen 550 of the telephony computing device 500. The rate entry controls may allow the user to input a rate change, including a changed rate and any surcharge, to be used when billing the calling party for the incoming call from the telephony computing device 600.

At 916, a rate change may be received. For example, the user may use the rate entry controls to input a rate change, including a changed rate and any surcharge. The telephony application 510, or rate selection application 710, may receive the rate change input by the user.

At 918, a rate storage control may be displayed. For example, the telephony application 510, or rate selection application 710, may display a rate storage control, for example, on the touchscreen 550 of the telephony computing device 500. The rate storage control may allow the user to choose whether to store the rate change input by the user and received by the telephony application 510, or rate selection application 710, and the incoming calling entity identifier, in the rate change database 570 so that the rate change may be used for future calls from the incoming calling entity identifier.

At 920, if the rate change will be stored, flow may proceed to 922. Otherwise, flow may proceed to 906 where the rate change may be transmitted to the carrier. For example, the user may use the rate entry controls on the touchscreen 550 to indicate that the rate change input y the user should be stored in the rate change database 570.

At 922, the rate change and incoming calling entity identifier may be stored in the rate change database. For example, the telephony application 510, or rate selection application 710, may write the rate change input by the user, including the changed rate and any surcharge, to the rate change database 570 along with the incoming calling entity identifier. This may allow the rate change input by the user to be retrieved on future calls received from the incoming calling entity identifier. Flow may then proceed to 906, where the rate change may be transmitted to the carrier.

At 924, if the call is accepted, flow may proceed to 908. Otherwise, flow may proceed to 926. For example, the user may use the rate selection control to indicate acceptance of the call without a rate change.

At 926, the call may be dismissed. For example, the user may use the rate selection control to dismiss the call. No rate change may be implemented.

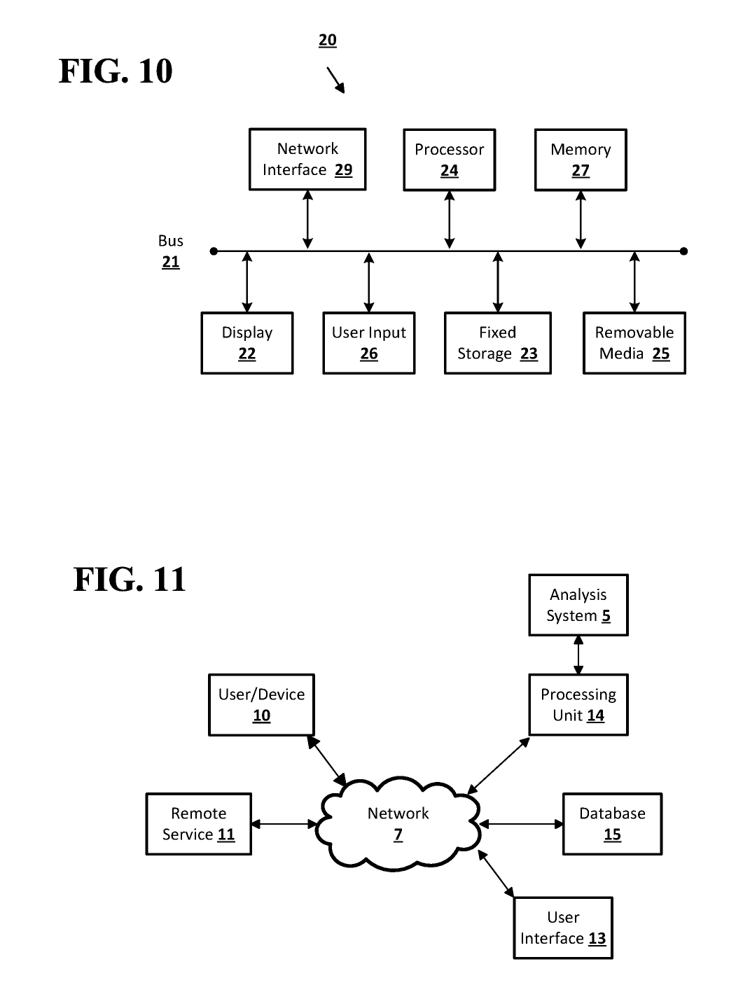

Implementations of the presently disclosed subject matter may be implemented in and used with a variety of component and network architectures. FIG. 10 is an example computer 20 suitable for implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection, or the like. For example, the network interface 29 may allow the computer to communicate with other computers via one or more local, wide-area, or other networks, as shown in FIG. 11.

Many other devices or components (not shown) may be connected in a similar manner (e.g., document scanners, digital cameras, and so on). Conversely, all of the components shown in FIG. 10 need not be present to practice the present disclosure. The components can be interconnected in different ways from that shown. The operation of a computer such as that shown in FIG. 10 is readily known in the art and is not discussed in detail in this application. Code to implement the present disclosure can be stored in computer-readable storage media such as one or more of the memory 27, fixed storage 23, removable media 25, or on a remote storage location.

FIG. 11 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. The disclosed subject matter also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions.

Implementations may use hardware that includes a processor, such as a general-purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

A rate change database referred to herein may associate calling rates with a specific phone number, or with any other identifier of the calling entity. Such entity may possess and use more than one phone number, or change numbers. Such entity may also be owned by or associated with other entities that may share the same calling rate changes.

A rate change database may be implemented in a variety of storage mechanisms, database management systems, file systems, or any other method of structuring data and accessing it for storage.

Various methods of structuring, storing, and accessing data so that rate structures may be associated with phone numbers, or entities are well known to practitioners of programming and data management.

Various methods of structuring, storing, and accessing data so that phone numbers and entities may be associated with each other in various relationships are well known to practitioners of programming and data management.

1. A computer-implemented method performed by a data processing apparatus, the method comprising:
receiving, with a communications device of a computing device, an incoming call associated with an incoming calling entity identifier;
displaying, on an interface of the computing device, the incoming calling entity identifier and a rate selection control comprising a control for changing the rate of the incoming call;
receiving, through the interface, a selection by the user of the control for changing the rate of the incoming call;
displaying, on the interface of the computing device, rate entry controls comprising a control for receiving input of a rate change for the incoming call;
receiving, through the interface, input of the rate change for the incoming call, wherein the rate change comprises one or both of a changed rate and a surcharge;
transmitting, to at least one carrier system responsible for routing the incoming call to the computing device, the rate change for the incoming call; and
accepting, by the computing device, the incoming call.

2. The computer-implemented method of claim 1, further comprising:
displaying, on the interface of the computing device, a rate storage control comprising a control for storing the rate change;
receiving, through the interface, a selection by the user of the control for storing the rate change; and
storing the rate change with the incoming calling entity identifier in a rate change database.

3. The computer-implemented method of claim 2, further comprising:
receiving, with the communications device of the computing device, a second incoming call associated with the incoming calling entity identifier;
determining that the incoming calling entity identifier is stored in the rate change database;
receiving the rate change stored with the incoming calling entity identifier from the rate change database; and
transmitting, to the at least one carrier system responsible for routing the incoming call to the computing device, the rate change for the second incoming call.

4. The computer-implemented method of claim 1, further comprising, before displaying, on the interface of the computing device, the incoming calling entity identifier and the rate selection control comprising the control for changing the rate of the incoming call:
determining that the incoming calling entity identifier is not stored in a rate change database.

5. The computer-implemented method of claim 1, wherein the changed rate input by the user comprises a monetary value to be charged on a per time unit basis to a calling party that placed the incoming call.

6. The computer-implemented method of claim 1, wherein the computing device comprises a telephony computing device.

7. The computer-implemented method of claim 1, wherein the incoming call is received by a telephony application of the computing device.

8. The computer-implemented method of claim 7, wherein a rate selection application of the computing devices interfaces with the telephony application of the computing device to display one or more of the rate selection control and the rate entry controls on the interface.

9. The computer-implemented method of claim 1, wherein the incoming call comprises an audio call or a video call carried over one or more of a wired telephone network, a wireless telephone network, a wired data network, and a wireless data network.

10. A computer-implemented system for incoming call rate selection comprising:
a storage device;
one or more communications devices that receive an incoming call associated with an incoming calling entity identifier;
an interface;
a processor displays, on the interface, the incoming calling entity identifier and a rate selection control comprising a control for changing the rate of the incoming call, receives, through the interface, a selection by the user of the control for changing the rate of the incoming call, displays, on the interface of the computing device, rate entry controls comprising a control for receiving input of a rate change for the incoming call, receives, through the interface, input of the rate change for the incoming call, wherein the rate change comprises one or both of a changed rate and a surcharge, transmits using the one or more communications devices, to at least one carrier system responsible for routing the incoming call to the computing device, the rate change for the incoming call, accepts the incoming call.

11. The computer-implemented system of claim 10, wherein the processor further displays, on the interface, a rate storage control comprising a control for storing the rate change, receives, through the interface, a selection by the user of the control for storing the rate change, and stores the rate change with the incoming calling entity identifier in a rate change database in the storage device.

12. The computer-implemented system of claim 11, wherein the processor further receives, with the one or more communications devices, a second incoming call associated with the incoming calling entity identifier, determines that the incoming calling entity identifier is stored in the rate change database in the storage device, receives the rate change stored with the incoming calling entity identifier from the rate change database in the storage device, and transmits, using the one or more communications devices, to the at least one carrier system responsible for routing the incoming call, the rate change for the second incoming call.

13. The computer-implemented system of claim 10, wherein the processor determines that the incoming calling entity identifier is not stored in a rate change database before the processor displays, on the interface, the incoming calling entity identifier and the rate selection control comprising the control for changing the rate of the incoming call.

14. The computer-implemented system of claim 10, wherein the changed rate input by the user comprises a monetary value to be charged on a per time unit basis to a calling party that placed the incoming call.

15. The computer-implemented system of claim 10, wherein the incoming call is received by a telephony application.

16. The computer-implemented method of claim 15, wherein the processor further executes a rate selection application that interfaces with the telephony application to display one or more of the rate selection control and the rate entry controls on the interface.

17. The computer-implemented method of claim 10, wherein the incoming call comprises an audio call or a video call carried over one or more of a wired telephone network, a wireless telephone network, a wired data network, and a wireless data network.

18. A system comprising: one or more computers and one or more storage devices storing instructions which are operable, when executed by the one or more computers, to cause the one or more computers to perform operations comprising:
receiving, with a communications device of a computing device, an incoming call associated with an incoming calling entity identifier;
displaying, on an interface of the computing device, the incoming calling entity identifier and a rate selection control comprising a control for changing the rate of the incoming call;
receiving, through the interface, a selection by the user of the control for changing the rate of the incoming call;
displaying, on the interface of the computing device, rate entry controls comprising a control for receiving input of a rate change for the incoming call;
receiving, through the interface, input of the rate change for the incoming call, wherein the rate change comprises one or both of a changed rate and a surcharge;
transmitting, to at least one carrier system responsible for routing the incoming call to the computing device, the rate change for the incoming call; and
accepting, by the computing device, the incoming call.

19. The system of claim 18, wherein the instructions further cause the one or more computers to perform operations further comprising:
displaying, on the interface of the computing device, a rate storage control comprising a control for storing the rate change;
receiving, through the interface, a selection by the user of the control for storing the rate change; and
storing the rate change with the incoming calling entity identifier in a rate change database.

20. The system of claim 19, wherein the instructions further cause the one or more computers to perform operations further comprising
receiving, with the communications device of the computing device, a second incoming call associated with the incoming calling entity identifier;
determining that the incoming calling entity identifier is stored in the rate change database;
receiving the rate change stored with the incoming calling entity identifier from the rate change database; and
transmitting, to the at least one carrier system responsible for routing the incoming call to the computing device, the rate change for the second incoming call.
